(19) United States
(12) Patent Application Publication
(10) Pub. No.: US 2014/0221885 A1
(43) Pub. Date: Aug. 7, 2014

(54) Underwear Assembly Incorporating a Vibrator

(71) Applicant: Morganne K. Fleschere, Huntington Beach, CA (US)

(72) Inventor: Morganne K. Fleschere, Huntington Beach, CA (US)

(21) Appl. No.: 13/758,437

(22) Filed: Feb. 4, 2013

(51) Int. Cl. A61H 1/00

(52) U.S. Cl. CPC A61H 1/00
USPC 601/46

(57) ABSTRACT

An underwear assembly has a front section, a rear section, side sections that connect the front section and the rear section along the sides of the front and rear sections, and a crotch section that connects the front section and the rear section at the bottom of the front and rear sections, the crotch section having a front lining positioned adjacent the front section which includes a pocket. A vibrator is positioned inside the pocket of the crotch section for stimulating the vaginal area of a woman.

### BACKGROUND OF THE INVENTION

1. Field of the Invention

The present invention relates generally to undergarments and to sexual pleasure devices, and in particular, to an underwear which allows a vibrator to be incorporated for hands-free use during intercourse when worn by a woman.

2. Description of the Prior Art

Sexual pleasure devices include vibrators, which are used by women for stimulating the clitoris. Most of these vibrators are stand-alone devices, and to be used, the woman must position the vibrator at the genital area and hold the vibrator at the genital area. This is usually done in private, or away from public areas, as it could be inconvenient and perhaps embarrassing for a woman to be holding a finger or hand at her genital area in public.

Many women do not enjoy having intercourse as much as their male partners because they have trouble reaching orgasm during intercourse. Many women need outside stimulation, but were too embarrassed to ask, or thought it undignified to use a hand-held device with their partner. Those women who were comfortable using a device during intercourse found the devices to be either inconvenient or uncomfortable, or found that they were not happy about needing to hold something, or found that the devices were bulky or distracting.

### SUMMARY OF THE DISCLOSURE

One objective of the present invention is to provide a vibrator which can be used by a woman during intercourse in a discreet and dignified manner

To accomplish the objectives set forth above, the present invention provides an underwear assembly having a front section, a rear section, side sections that connect the front section and the rear section along the sides of the front and rear sections, and a crotch section that connects the front section and the rear section at the bottom of the front and rear sections, the crotch section having a front lining positioned adjacent the front section which includes a pocket. A vibrator is positioned inside the pocket of the crotch section for stimulating the vaginal area of a woman and contains a slit to allow for the insertion of a male organ therethrough.

### BRIEF DESCRIPTION OF THE DRAWINGS

FIG. 1 is a front view of a woman's underwear according to one embodiment of the present invention.

FIG. 2 is a rear view of the underwear of FIG. 1.

FIG. 3 is an opened view of the interior of the underwear of FIG. 1.

FIG. 4 is an opened view of the exterior of the underwear of FIG. 1.

FIG. 5 is a perspective view of a vibrator that can be used with the underwear of FIG. 1.

FIG. 6 is an exploded perspective view of the vibrator of FIG. 5.

FIG. 7 is a side plan view of the vibrator of FIG. 5.

### DETAILED DESCRIPTION OF THE PREFERRED EMBODIMENTS

The following detailed description is of the best presently contemplated modes of carrying out the invention. This description is not to be taken in a limiting sense, but is made merely for the purpose of illustrating general principles of embodiments of the invention. The scope of the invention is best defined by the appended claims.

The present invention provides a novel woman's underwear that is adapted to hold a vibrator at the genital area so that the vibrator can be used when the underwear is worn. The vibrator may be removed and used with different underwear that have the same construction described herein.

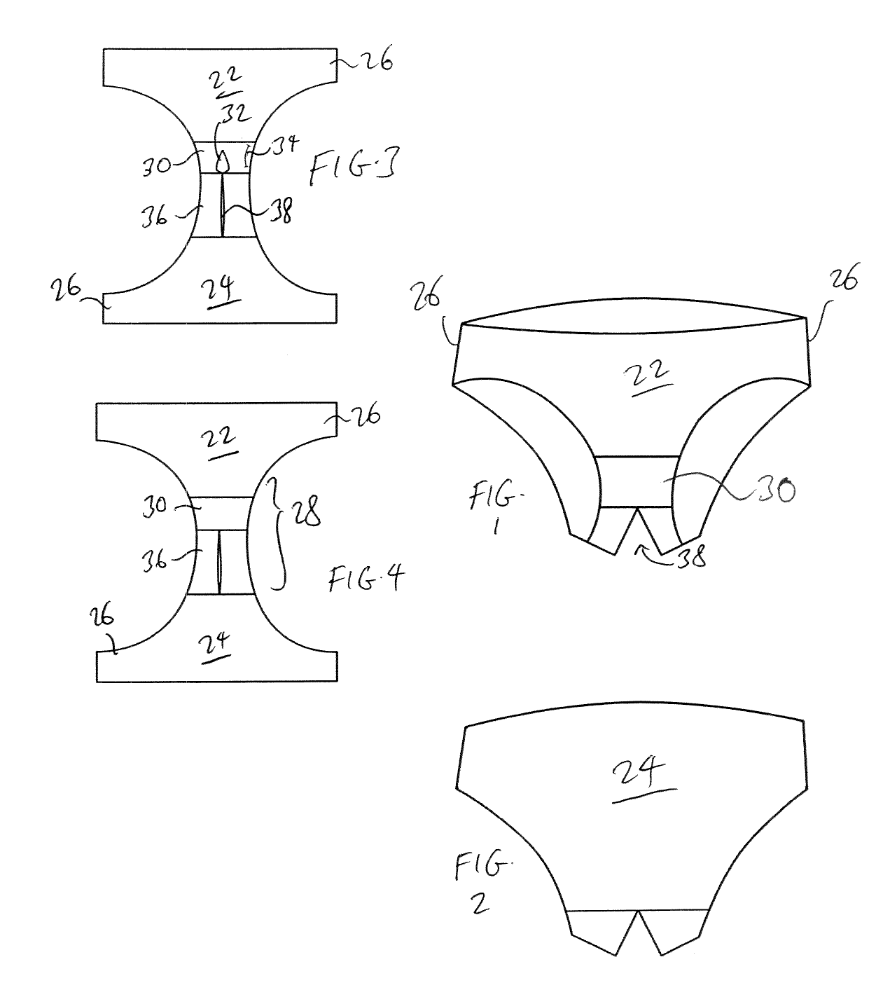

Referring to FIGS. 1-4, the underwear 20 according to an embodiment of the present invention has a front section 22, a rear section 24, side sections 26 that connect the front section 22 and the rear section 24 along the sides, and a crotch section 28 that connects the front section 22 and the rear section 24 at the bottom. The various sections 22, 24, 26 and 28 can be made from conventional fabric (e.g., cotton) that is used for conventional underwear. As shown in FIG. 3, the crotch section 28 has a cotton lining 30 positioned adjacent the front section 22 that forms a pocket for holding a vibrator 40. The pocket has an opening 32 through which a raised lip 66 of the vibrator 40 is positioned. The raised lip 66 has a slope that is exposed to the womans genitals (via the opening 32) for the purpose of stimulating the clitoris. A small slit opening 34 is provided along the edge of the cotton lining 30 to allow the vibrator 40 to be inserted therethrough into the pocket . The crotch section 28 also includes a rear lining 36 positioned along the remainder of the crotch section 28 (extending from the front lining 30 to the rear section 24), with an elongated slit opening 38 extending from adjacent the front lining 30 to adjacent the rear section 24, with the slit opening 38 adapted to allow access of a male organ for intercourse.

In use, a small vibrator 40 (as shown and described below) can be inserted through the opening 34 into the pocket exposing the lip 66 through the opening 32. The pocket and the opening 32 are positioned to be at about the local of a woman's genital area so that when the vibrator 40 is actuated, the vibrator 40 can stimulate a woman's clitoris. The vibrator 40 can be removed when the underwear 20 is to be washed, or if the vibrator 40 is intended for use with different underwear 20.

FIGS. 5-7 illustrate the vibrator 40. The vibrator 40 is generally rectangular in shape, and includes a housing assembly 42 that is encased by an over-molded rubber piece 44 and an injection-molded diamond base 46. The housing assembly 42 includes an injection-molded housing base 48 and an injection-molded housing top 50. The housing base 48 has a motor support 52 that holds a motor 54, and a battery compartment 56 for receiving a battery 58. An on-off switch 60 is positioned inside a switch locater 62 on the housing base 48. The housing top 50 includes an opening 64 that is aligned with the switch locater 62 so that the switch 60 can extend therethrough. The housing top 50 can be snap-fitted, or secured using any other conventional method, to the housing base 48.

The housing top 50, the housing base 48 and the diamond base 46 are all injection-molded from a transparent plastic, such as polystyrene, polyester or acrylic. The diamond base 46 is provided with a faceted surface with a metal chrome coating to create a jewel-like reflection when viewed from the outside, which functions to create a an elegant impression while shielding the interior from external view.

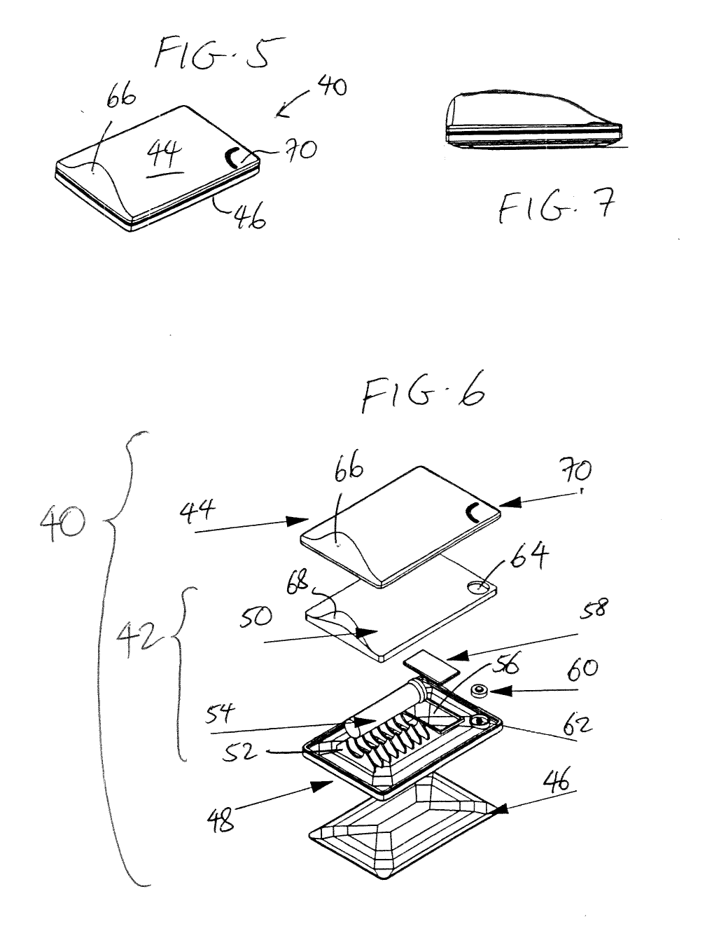

The over-molded rubber piece 44 and the housing top 50 are provided with a raised lip 66 and 68, respectively, at their front sides. The raised lip 66 on the rubber piece 44 functions to stimulate the vaginal area of the woman when the vibrator 40 is positioned inside the pocket 32. As best seen in FIG. 7, the raised lip 66 extends vertically gradually from the rear of the rubber piece 44 to a height which remains constant from about the middle of the rubber piece 44 to the front of the rubber piece 44. As best in FIGS. 5 and 6, the lip 66 slopes gradually downwardly from its vertical height. An on-off button 70 is provided on the opposite side of the rubber piece 44 at a location aligned with the on-off switch 60. The vibrator 40 can be actuated by the woman or her partner by turning on the switch 60.

The rubber piece 44 does not need to be made of rubber, but it should be made of a soft material such as rubber or silicone.

Thus, the present invention provides a stimulation device that is beautiful (i.e., shaped to look like a jewel), and which can be conveniently used by a woman during intercourse with a partner. For the couple, turning the vibrator 40 on or off is as simple as having a man putting on a condom or for the woman a contraceptive. The woman merely inserts the vibrator 40 either in front of her partner or in the privacy of a bathroom, so no discussion or requests are necessary. The discretion of the pocket conceals the vibrator, so that it is used in a more dignified manner. Thus, the underwear assembly of the present invention helps provide assistance for a woman who may not be able to reach orgasm during intercourse on her own.

While the description above refers to particular embodiments of the present invention, it will be understood that many modifications may be made without departing from the spirit thereof. The accompanying claims are intended to cover such modifications as would fall within the true scope and spirit of the present invention.

What is claimed is:

1. An underwear assembly, comprising:
a front section, a rear section, the front and rear sections having a bottom and opposing sides,
side sections that connect the front section and the rear section along the sides of the front and rear sections,
a crotch section that connects the front section and the rear section at the bottom of the front and rear sections, the crotch section having a cotton lining positioned adjacent the front section which includes a pocket; and
a vibrator positioned inside the pocket of the crotch section.

2. The assembly of claim 1, wherein the crotch section further includes a small slit opening provided along an edge of the lining to allow the vibrator to be inserted therethrough into the pocket.

3. The assembly of claim 1, wherein the crotch section also includes a rear lining positioned along the remainder of the crotch section and extending from the cotton lining to the rear section, with an elongated slit opening extending from adjacent the front lining to adjacent the rear section.

4. The assembly of claim 1, wherein the vibrator is generally rectangular in shape, and includes a housing assembly with a motor and a battery housed therein, and a switch associated with the housing assembly for actuating the motor, the vibrator further including a top piece that made of a soft material, the top piece having a raised lip.
